(19) United States
(12) Patent Application Publication
(10) Pub. No.: US 2024/0140849 A1
(43) Pub. Date: May 2, 2024

(54) Water Treatment Modules and Method of Use Thereof

(71) Applicants: William TALLY, Farmington Hills, MI (US); Renew Health Ltd, Athlone (IE)

(72) Inventors: William Tally, Milford, MI (US); Jeffrey Dupuis, Royal Oak, MI (US); Victor Aldana, Farmington Hills, MI (US); Mitch O'Brien, Royal Oak, MI (US); Alex Ruffolo, Ferndale, MI (US); Jack Juni, Royal Oak, MI (US); Thomas Reesbeck, Farmington Hills, MI (US)

(73) Assignee: Renew Health Ltd, (omitted)

(21) Appl. No.: 18/280,711

(22) PCT Filed: Mar. 7, 2022
(86) PCT No.: PCT/US2022/019184

§ 371 Date: Sep. 7, 2023

Related U.S. Application Data
(60) Provisional application No. 63/157,804, filed on Mar. 7, 2021.
(60) Provisional application No. 63/157,994, filed on Mar. 8, 2021.

(51) Int. Cl. C02F 9/20

(52) U.S. Cl. CPC C02F 9/20; C02F 2101/103

(57) ABSTRACT

The disclosure relates to water treatment modules that may be adapted to achieve required standards of capacity or purity. The disclosure describes the linkage of different water treatment treatment modules to achieve the required standards.

### BACKGROUND

The quality of the public water supply is an ongoing issue and water treatment methods that supplement or replace those used in the public supply is increasing in popularity. Further, in many situations, access to the public water supply may be limited and standalone water treatment systems may be the only way to purify water. For example, well water may be the only available water source.

In these and other situations, water treatment systems must be adaptable to particular sources of water. For example, a water source may have particularly high levels of selected contaminants, such as iron or arsenic, or sediment, and water treatment modules that are easily adaptable or customized to remove the specific contaminants would be desirable. In addition, it would be advantageous to have water treatment modules that may be easily adapted to changes in the water supply over time.

In addition, different users have different standards and requirements for water treatment. For example, residential users may require less water treatment capacity than commercial users. Some users may also require water treated to higher purity standards. For example, water for medical or scientific uses require particularly high standards of water, such as for dialysis, laboratory use, or for the preparation of medications. It would be very desirable to have an easily adaptable water treatment module that can achieve the required capacity, the required water purity standards or achieve both desired capacity and/or purity. It would also be desirable to achieve these goals with an easily maintained and inexpensive system.

### SUMMARY

The disclosure relates to water treatment modules that are adaptable to particular water purification situations, such as a required capacity or a required standard of purity. According to the disclosure, water treatment modules may be connected to achieve these requirements where the treatment modules incorporate different materials and media.

In some examples, treatment modules of the disclosure are configured to utilize filtration media, such as sediment filters, activated carbon, or media that removes iron and arsenic. The filtration water treatments systems may be fluidly connected to modules or systems that employ other methods of water treatment, such as reverse osmosis systems and modules.

### BRIEF DESCRIPTION OF THE DRAWINGS

FIG. 1 shows the exterior of a water treatment module according to the disclosure

FIG. 2a shows a further example of a water treatment module according to the disclosure showing the interior of the module.

FIG. 2b shows a view of the of a water treatment module of FIG. 2a showing a further view of the interior of the module as seen from the front.

FIG. 2c shows a view of the of a water treatment module of FIG. 2a showing a further view of the interior of the module a seen from the side

FIG. 3 shows a further example of a water treatment module according to the disclosure

FIG. 4a shows a view of a water treatment module according to the disclosure with panels removed to show the interior

FIG. 4b shows the water treatment module of FIG. 4a as seen from above with a top panel removed.

FIG. 5a shows an, example of the arrangement of media manifolds in a water treatment module

FIG. 5b shows a further view of the water treatment module of FIG. 5a.

FIG. 6a shows a schematic of the flow of water through rows of media tanks arranged in parallel

FIG. 6b shows a schematic of the flow of water through rows of media tanks arranged in series

FIG. 7a shows one example of a reverse osmosis module according to the disclosure

FIG. 7b shows the reverse osmosis module of FIG. 7a as seen from above.

FIG. 8a shows an example of a water treatment module according to the disclosure

FIG. 8b shows the water treatment module of FIG. 8a as seen from above.

FIG. 9 shows an assembly of a water treatment module according to the disclosure

FIG. 10 shows an assembly of a water treatment modules according to the disclosure

FIG. 11 shows an assembly of a water treatment modules according to the disclosure

### DETAILED DESCRIPTION

The systems and methods described herein are not limited in their application to the details of construction and the arrangement of components set forth in the description or illustrated in the drawings. The present disclosure is capable of other disclosure and of being practiced or of being carried out in various ways. Also, the phraseology and terminology used herein is for the purpose of description and should not be regarded as limiting. The use of “including”, “comprising”, “having”, “containing”, “involving” and variations thereof herein, is meant to encompass the items listed thereafter, equivalents thereof, and additional items, as well as alternate examples consisting of the items listed thereafter exclusively.

Other aspects, embodiments, and advantages of these exemplary aspects and embodiments are discussed in detail below. This description is intended to provide an overview or framework for understanding the nature and character of the claimed aspects and examples. The accompanying drawings are included to provide illustration and a further understanding of the various aspects and examples and embodiments and are incorporated in and constitute a part of this specification. The drawings, together with the specification, serve to explain the described and claimed aspects and embodiments.

The disclosure relates, to water treatment modules that may be assembled to build a water treatment system to achieve a desired water purity or achieve a desired water output (flow rate gallons per minute or capacity, total gallons) or both a desired output and purity. In preferred examples, the disclosure relates to water treatment modules that may be adapted or customized to particular requirements, such as selected standards of water purity or desired water treatment capacities, or a combination of these requirements. Water treatment modules of the disclosure may be used for residential, commercial, private, or public applications. For example, water treatment modules may be placed near the entry site of the water supply into a building, including residences or commercial buildings. In other examples, treatment modules of the disclosure may be placed within residential, commercial or public buildings to achieve desired properties for the water.

In some examples, water treatment modules may include components that increase water purity to achieve established standards, such as government-specified standards. In preferred examples, treatment modules of the disclosure may be used for medical or scientific applications. In preferred examples, water outputted from the treatment module may be of sufficient quality to be used for dialysis procedures. In preferred examples, water outputted from treatment modules of the disclosure may be sufficient quality to be used in scientific laboratories. In preferred examples, water outputted from treatment modules of the disclosure may be of sufficient quality to be used for the preparation of medicines.

Treatment modules of the disclosure may be used with different feed water sources including, without limitation, the public water supply, well water, sea water, brackish water, or fresh water. Treatment modules of the disclosure may be adapted to changes in water composition over time. For example, entire treatment modules or components of treatment modules may be easily replaced to accommodate changes in water composition.

According to the disclosure, two or more treatment modules may be linked or connected to achieve desired properties of outputted water. Two or more treatment modules may be connected fluidly, mechanically, or electrically or some combination of these linkages. For example, water may flow from one treatment module to a second treatment module. In further examples, a third, a fourth, a fifth or more than five modules may be added where water may flow from module to module, where each module treats water using the same or different media to achieve the required purity or the required output. Treatment modules may be linked to other components, such as one or more storage tanks, pumps, or other water treatment components, such as water sterilization components, Connected modules may be placed in parallel or series, depending on requirements for output or purity.

In preferred examples, a treatment module includes an enclosure, at least one media tank or cartridges containing media or other components for water purification, and a media manifold. In general, the media tanks are vertically orientated such that input water enters and exits the tank through one or openings in the top of each tank.

In preferred examples, treatment modules have at least two media tanks that are connected in parallel such that the at least two tanks are side by side to form a row of tanks in the treatment module. In these examples, each of the in-parallel tanks in a row of tanks has the same type of media.

In preferred examples, at least two rows of at least two in-parallel tanks may be placed in a treatment module. In preferred examples, rows of in parallel tanks are placed immediately adjacent to each other. In preferred examples, treatment modules have one row of tanks, have two rows of tanks, or have three rows of tanks or more than three rows of tanks. Each row of tanks may contain the same or different media from adjacent rows.

Tanks of the treatment modules may include filtration media for removing sediment, may include activated carbon, may include media from removing iron and arsenic, or media for softening water. Treatment modules for filtration may be linked to reverse osmosis systems or modules, systems using ultrafiltration components, components that sterilize water, modules including deionizing resin or combinations of these modules. Individual treatment modules may have a combination of two or more components for water purification.

In preferred examples, water to be treated may be flowed through the treatment module continuously or may be pulsed through the treatment module depending on requirements, Water may also be flowed through the treatment module to permit back washing or regeneration of the cartridge material, such as from a brine media tank. In preferred examples, water treatment modules are capable of controlling the flow of water for purification, for backwashing the media, or for regenerating media.

In some examples, the water treatment module of this example may be standalone, having its own power source, sensors, flow meters, sensors, and controllers. For example, each water treatment module may have sensors that monitor total dissolved solids, where the concentration of total dissolved solids is relayed to a controller that may shut the module down or send an alarm if specifications of the system are exceeded. Similarly, each module may have flow meters to monitor water pressure throughout the module which information may be relayed to the controller, in preferred examples, each module may be monitored and controlled using Wifi networks or similar methods.

### Example 1 Treatment Module Including Filtration Media

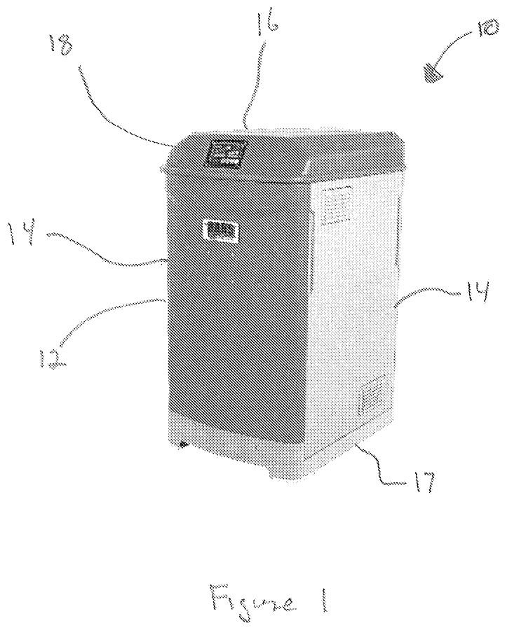

FIGS. 1-6 illustrates aspects of a treatment module that incorporates one or more types of filtration media. In general, the components of filtration treatment modules are very similar irrespective of the type of filtration media employed in the module. The use of interchangeable components such as media tanks and manifolds, allows for simplified assembly, maintenance, or adaptability of the treatment module. Table 1 provides non-limiting examples of filtration media that may be employed in water treatment modules of the disclosure

TABLE 1

| | Examples of impurities | |
|---|---|---|
| Type of Media | removed | Examples |
| Sediment | Material down to 20 | Zeosand |
| Filtration | microns | Zeosorb |
| | Material down to 5 | |
| | microns | |
| | Material down to 3 | |
| | microns | |
| Catalytic | Chlorine | |
| Carbon | Chloramine | |
| | Lead | |
| | Volatile organic | |
| | compounds | |
| Softener | Reduces water hardness | 10% Cross Link |
| | Iron | Resin |
| | Barium | |
| | Radium | |
| Iron/Arsenic | Iron | Katalox |
| | Sediment down to 3 | |
| | microns | |
| | Arsenic | |

FIG. 1 shows an example of an enclosure 10 that may be employed for the water treatment modules of the disclosure. The enclosure includes front panel 12, side panels 14, top panel 16, base 17 and status screen indicator 18. The status screen reflects data collected by the controller (not shown) concerning the system. The enclosure may be manufactured from ultraviolet-resistant resistant plastic.

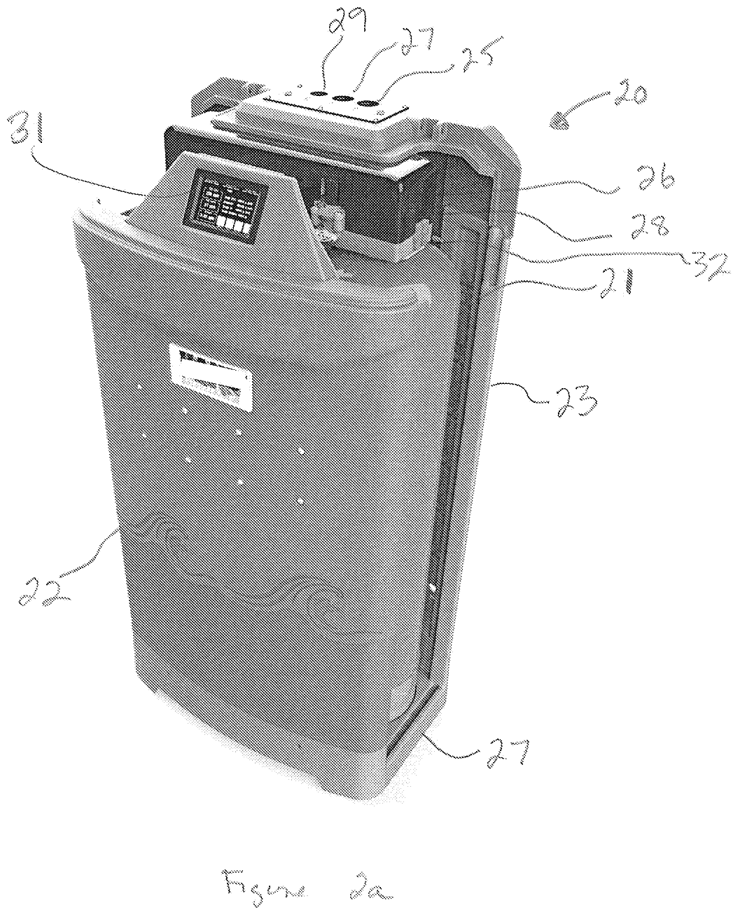

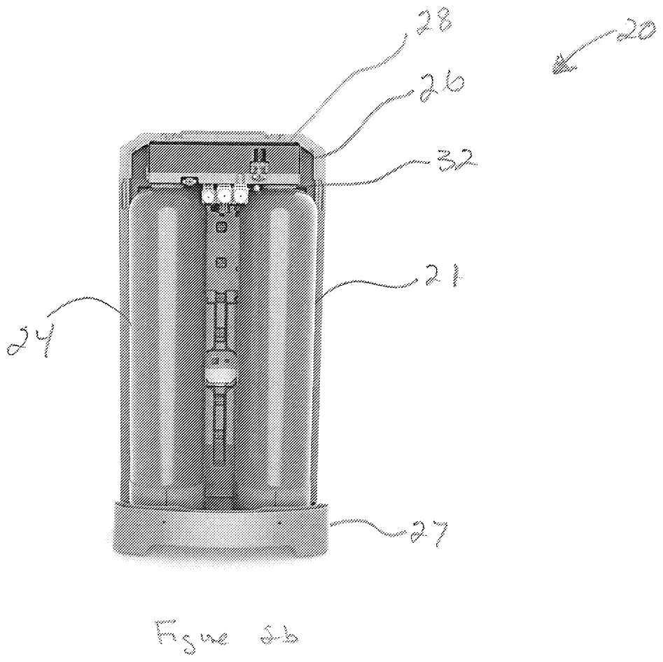

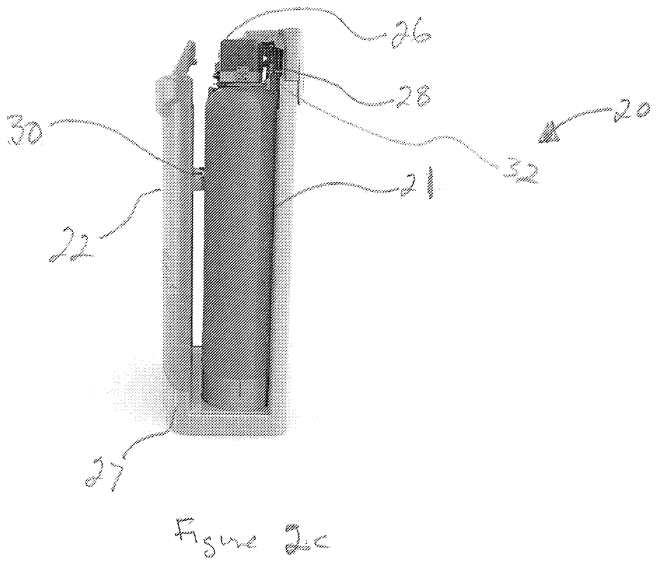

FIGS. 2a-c shows a further example of an enclosure. In this example, the enclosure 20 is smaller than the enclosure shown in FIG. 1, where this enclosure may, for example, be employed in a residential situation. In this example, the enclosure is about 21 inches deep, 29 inches wide and 59 inches high. Front panel 22 and base 27 is shown as well as rear panel 23. In FIGS. 2a-c, selected panels have been removed from the enclosure to show the interior of the treatment module. In this example, two media tanks 21, 24 is shown. Inlet 25, outlet 27, and drain 29 are placed on a rear panel of the enclosure 20 where water enters a treatment module through the inlet 25 and flows through manifold 26 to the media tanks. In this example, manifold 26 has cover 28. Status screen 31 is also shown.

The media tanks are orientated vertically such that water enters media tanks 22,24 from the top 32 of each tank and flows downward into the media. Module manifold 26 is mounted on the top of the tanks and includes gate valves controlled by solenoids to regulate the flow of water through the manifold (not shown in this figure). Mount 30 holds the tanks in place.

In this example, both media tanks have the same dimensions. For example, the media tanks in the example are cylindrical having a diameter of approximately 1.0 inches and a height of approximately 44 inches. In other examples, the media tank may take other shapes and dimensions.

In general, two filtration media tanks that are side by side, as shown in FIGS. 2a-c, are paired in having the same filtration media. The paired tanks form a row of tanks. The paired tanks (a row) are connected in parallel such that when water flows into the treatment module through inlet 25, then through module manifold 26, the water flows through both media tanks of the row simultaneously. Water pressure forces the feed water through the media in the tank, then through back through the top 32 of the tanks 22,24 to an outlet 27.

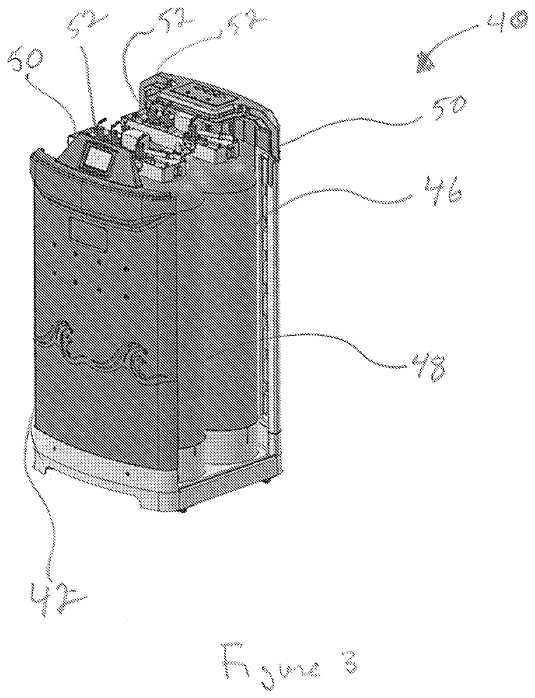

FIG. 3 shows a further example of a water treatment module 40 similar to the treatment module. The enclosure 42 is shown with side panels removed. In this example, the treatment module 40 has four vertically orientated filtration media tanks. A first row 46 having two tanks is positioned towards the rear of the enclosure and a second row 48 of two tanks is positioned immediately adjacent to the first row 48, towards the front of the enclosure. In this example, the cap of manifold 50 has been removed to show solenoids 52.

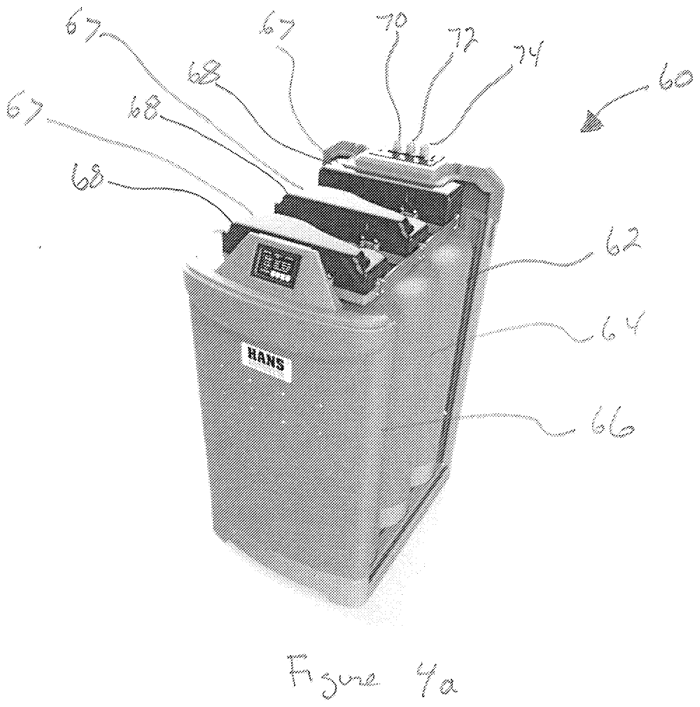

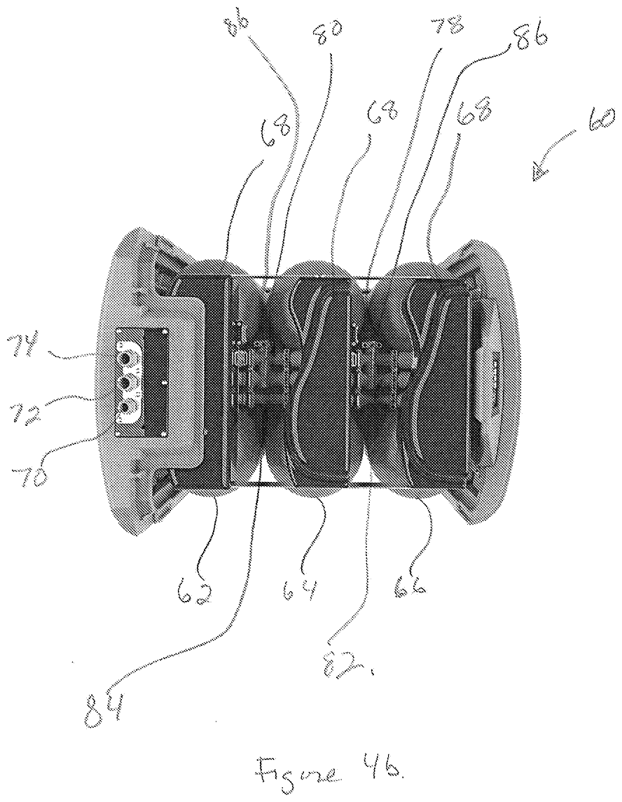

FIGS. 4a and 4b shows a further example of a filtration treatment module 60 according to the disclosure. FIG. 48 is a perspective view and FIG. 4b shows the example from the top. Inlet 74, outlet 72 and drain 70 are also shown. In this example, the module has six vertically orientated media tanks, arranged in a first row 62 of two tanks, a second row 64 of two tanks and a third row 66 of two tanks. In this example, the first row 62 of tanks is closest to the inlet, the second row 64 is immediately adjacent to the first row. The third row 66 is immediately adjacent to the second row 64. The tanks are closely spaced with no gap between adjacent tanks. This arrangement reduces required material, reduces the module's footprint, or facilitates maintenance.

Media manifolds 68 are positioned on top of each row of media tanks, covering the tops of the tanks. In this example, components of the manifold are protected by cap The configuration of the media manifolds 68 permits the arrangement of the media tanks and controls the flow of water through the pairs of tanks. FIG. 4b also shows first line 80, second line 82 and drain line 84. In this example, serial port connectors 86 are also shown where the port connectors fluidly connect first line 80 and manifold 68.

In some examples, all six tanks (three rows of two tanks in each row) may have the same media. For example, all six tanks may contain catalytic carbon. In this situation, each row of tanks may be arranged in parallel with adjacent rows to achieve the required output volume (for example, gallons) or output flow rate (for example, gallons per minute). In this case, the module manifolds 68 are configured to allow flow of input water through all six tanks simultaneously.

In other examples, each row of tanks may contain different types of media. For example, the first row of tanks 62, closest to the inlet, may contain media to reduce iron and arsenic, the second row of tanks may contain softener media, and the third row of tanks may contain catalytic carbon. In this example, each row of tanks is connected in series with the immediately adjacent row of tanks. In this example, the module manifolds are configured to allow flow of input water sequentially through each pair of tanks, where the water passes sequentially through each type of media, from iron/arsenic media to softener media to catalytic carbon media.

In other examples, two rows of tanks may have the same media and a third row may have a second type of media. For example, the first row may be a sediment filtration media and the remaining second and third rows may be softener media. In this case, the first and second rows may be positioned in series with each other and the second and third rows are positioned in parallel with each other. In this example, water flows first through the first row having sediment filtration media than then simultaneously flows through the second and third rows of media tanks having softener.

### Example 2

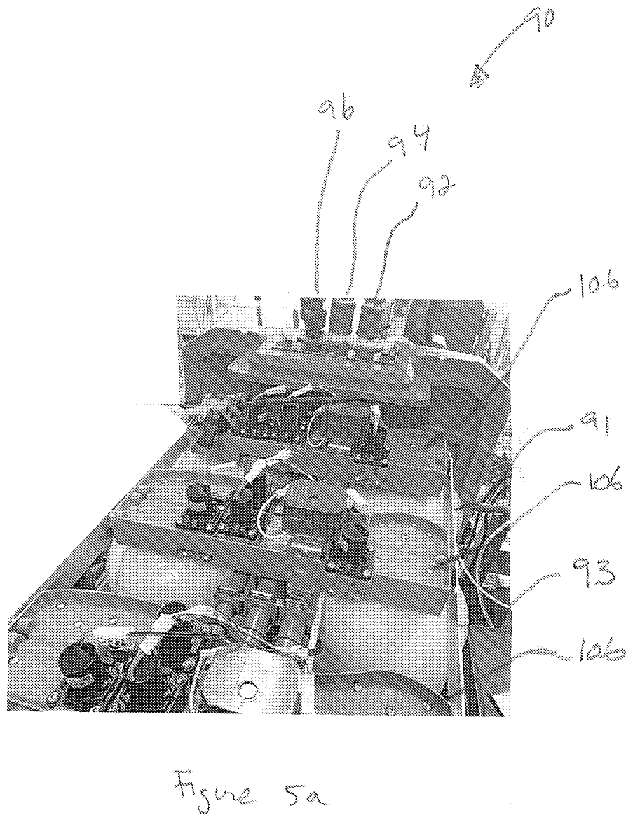

FIGS. 5a and 5b show views, of a treatment module 90 showing, enhanced views of media manifolds according to the disclosure. In this example, the caps of the manifolds have been removed. In FIG. 5a, inlet 92, outlet 94 and drain 96 are shown. These figures show three rows of media tanks 91,93 and 95, where row of tanks 91 is closest to inlet 92 and row 93 is immediately adjacent to row 91. Each row of tanks has two media tanks. In this example, the three rows of tanks are connected in parallel such that water flows to all tanks simultaneously. Each row of tanks has similar media manifolds 106, Also shown are solenoids 99 where solenoids control gate valves in media manifolds 106. Motors 98 are also shown positioned on each manifold where each motor drives the operation of solenoids in the respective media manifolds. First line 100, second line 102 and drain line 104 are shown most clearly in FIG. 5b.

In the example where rows of tanks are connected in series, one or more serial port connectors are inserted to fluidly connect manifolds with first line 100. Serial connectors 86 are shown in FIG. 4b.

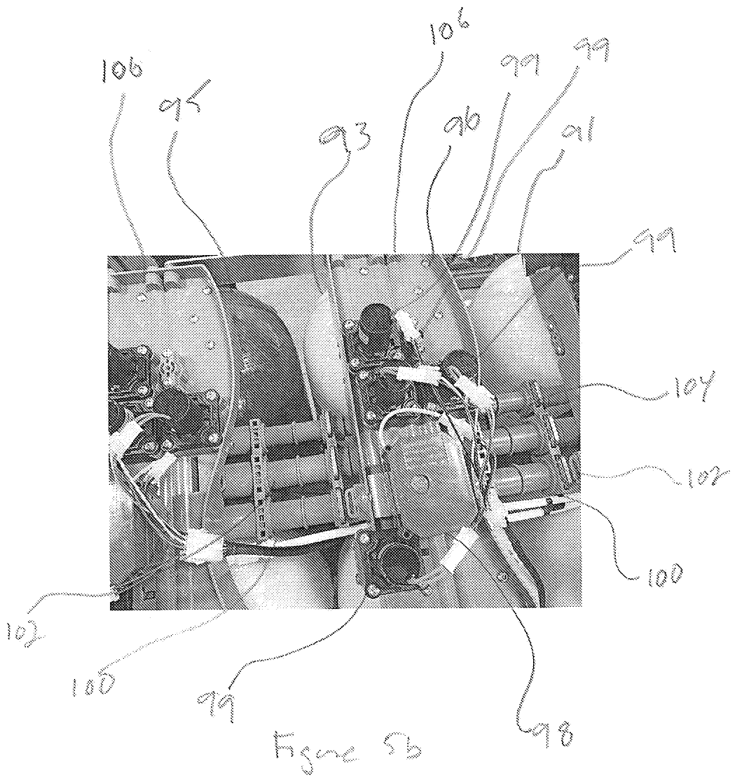

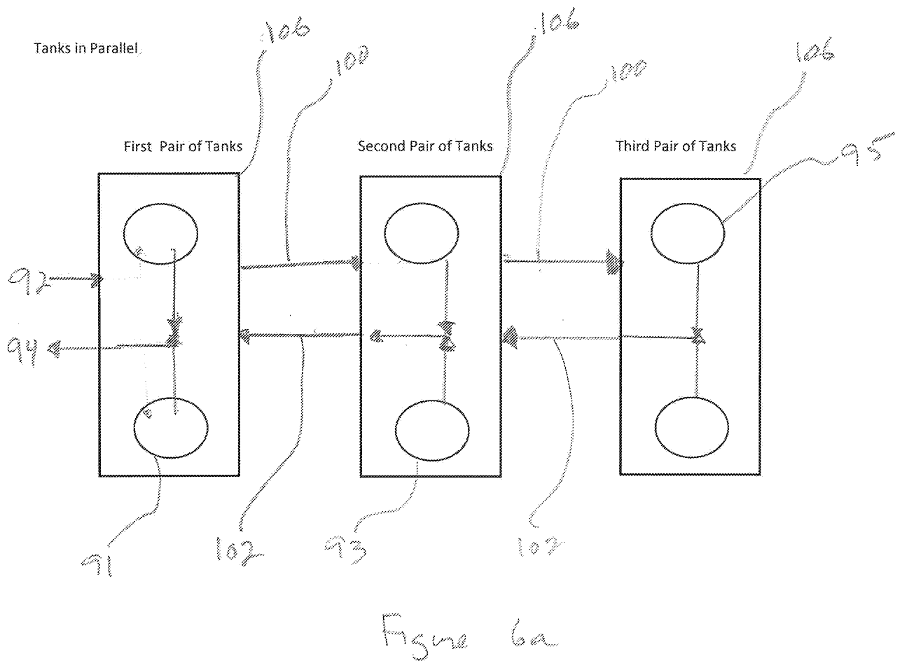

FIG. 6a and FIG. 6b shows schematics of the flow of input water through the system. When rows of tanks are in all in parallel, the flow of water is similar to that shown in FIG. 6a. In this example, water flows from inlet 92 to first line 100 and flows through the media module 96 mounted on tank row 91 when solenoids 99 open gate valves. A portion of the water flows through the media in the tanks of row 91 and the remainder of the water flows through first line 100 to the manifolds positioned on second 93 and third 95 rows of tanks. For each row of tanks, water flows through the media and exits the tanks, then flows through the second line 102 to outlet 94.

In FIG. 6b, the flow of water is shown when the rows of tanks are positioned in series and water flows sequentially through each row of tanks. In this example, water flows from inlet 92 to first line 100 and flows through the media manifold 96 mounted on tank row 91 when solenoids 99 open gate valves. Water exits both tanks of row 91 and passes through a serial port connector 103 that is fluidly connected to first line 300. The water treated in the first row of tanks thereby flows to the second row of tanks for treatment. Similarly, water exiting the second of row of tanks flows through a second serial port connector 103 to flow treated water to the first line:100 for treatment in the third row of tanks. Treated water exiting the third row of tanks flows to second line 102 and thereby to outlet 94. The above descriptions also apply to situations where rows of tanks are in both in series and in parallel.

### Example 3

In preferred examples, one or more filtration treatment modules may be linked to a further module or system employing an additional method for purifying water. In particularly preferred examples, the one or more filtration treatment modules may be linked in series or in parallel with at least one reverse osmosis system or module.

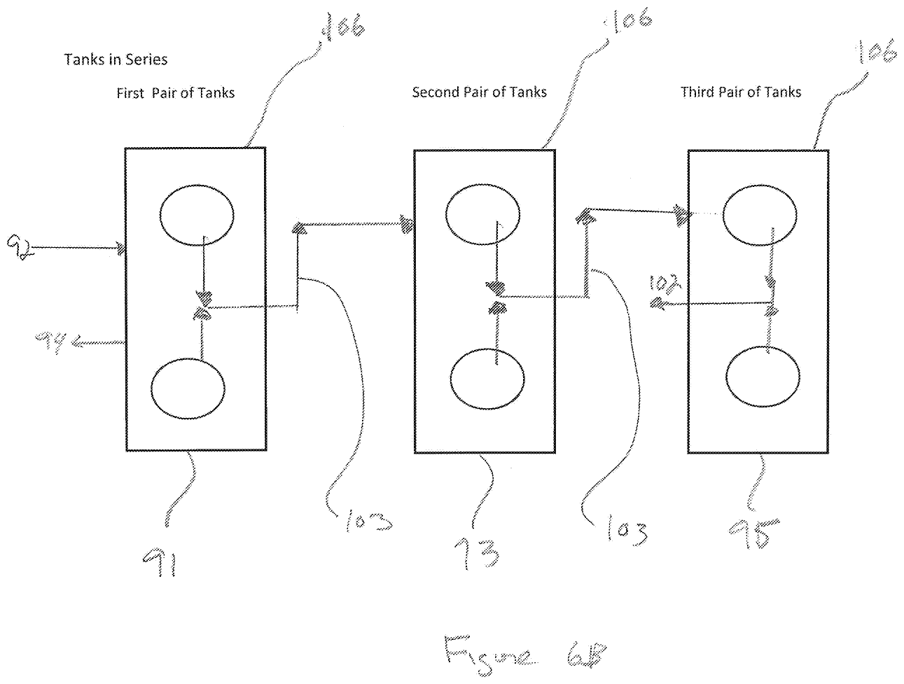

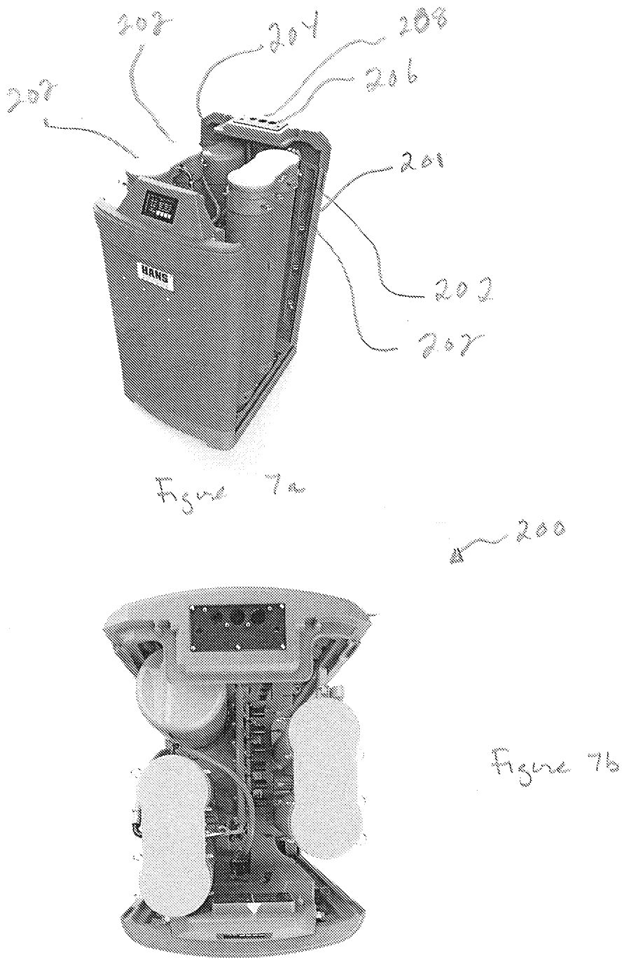

FIGS. 7a and 7b shows one example of a reverse osmosis system 200, shown in a perspective view and as seen from above. In this example, panels have been removed from the enclosure 201 to show the interior. This example shows four reverse osmosis cartridges 202, linked in parallel. Surge tank 204 is also shown.

In additional examples, additional water treatment methods may be employed using further modules or system, depending on requirements. For example, water may be passed through previously described filtration treatment module where the tanks contain calcite. In this case, carbon dioxide may be reduced, and the pH of the output water stabilized.

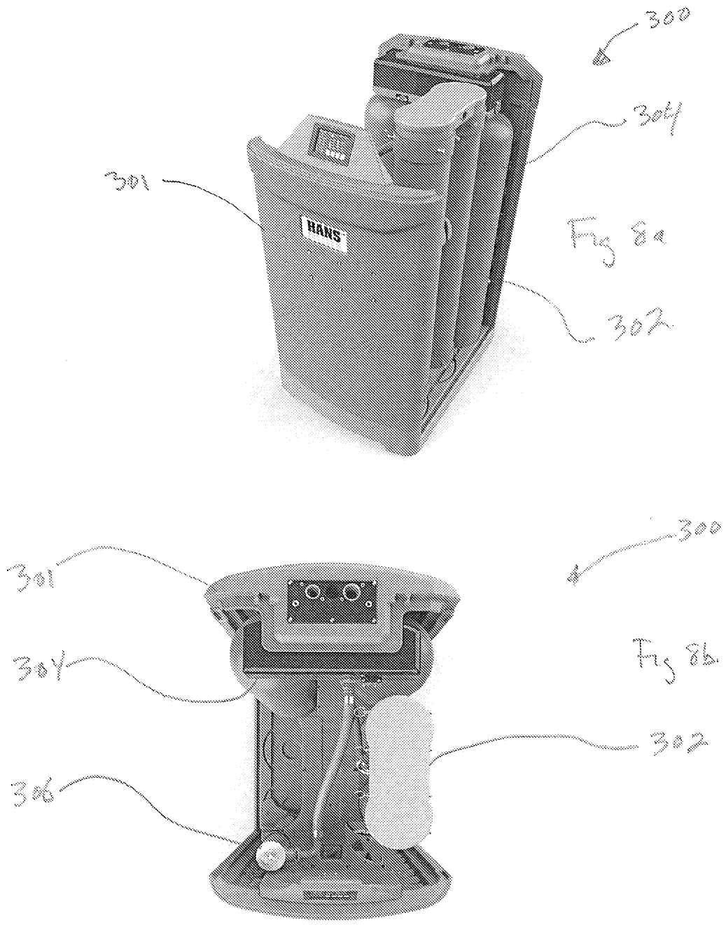

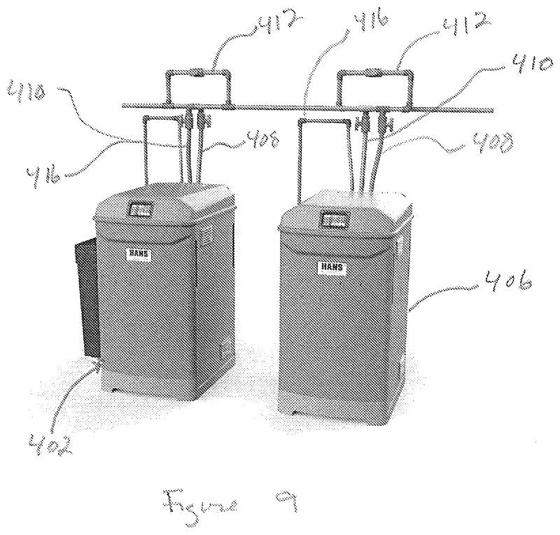

In additional examples, modules that produce sterile and ultrapure water for laboratory use may be utilized. FIGS. 8a and b shows a module that includes two cartridges in parallel for deionizing water 304, two cartridges in parallel for ultrafiltration 302, and for ultraviolet light sterilization 306. In other examples, further treatment modules have one or more of deionizing resin, ultrafiltration cartridges or ultraviolet sterilization. According to this example, water with a resistivity of greater than 18 megaohmirneter may be outputted. According to this example, a resistivity meter may be present with a linked alarm to indicate failure of the treatment module to achieve the preset standard.

### Example 4

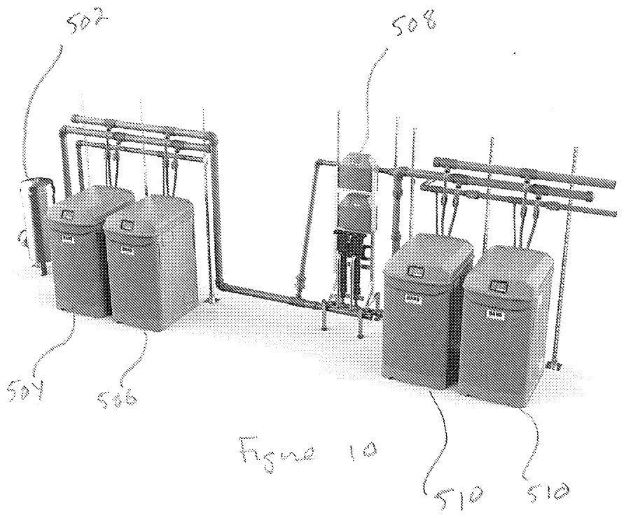

FIG. 9 shows one assembly or system of modules for purifying water. The arrangement described here would be suitable for a residential situation. In this example, a filtration module 402 is fluidly linked to a reverse osmosis module where input water first flows through the filtration module then flows to the reverse osmosis module. For example, the filtration module may contain a first row of sediment filter tanks and two rows of softener tanks. The reverse osmosis module may contain two reverse osmosis cartridges. In this example, the system is capable of more than 9 gallons per minute output. Inlet 410, drain 416, outlets 408 are shown for each outlet. Bypass line 412 is also indicated.

### Example 5

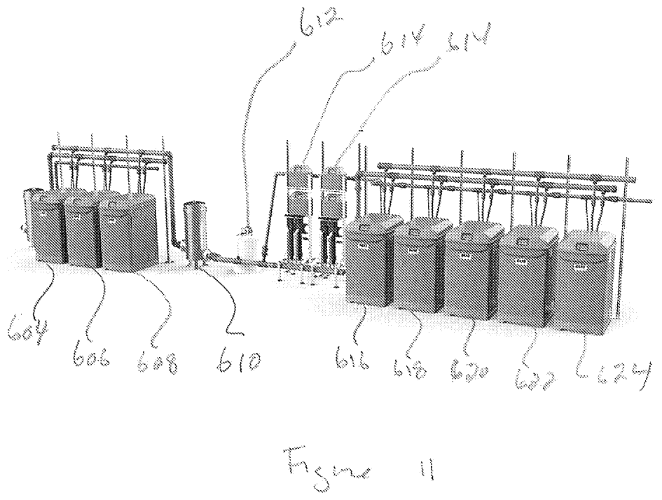

FIG. 10 shows one assembly or system of modules for purifying water. The arrangement described here would be suitable for a large residential or smaller commercial situation. In this example, input water is first flowed to sediment filtration module 502 to remove materials down to about 20 microns. The water then flows to a first treatment module 504 with three pairs (rows) of tanks with softener media. The water then flows to a second treatment module 506 with three pairs (rows) of tanks having catalytic carbon. The second treatment module 506 is fluidly connected in series with reverse osmosis modules 510 where the reverse osmosis modules each have four reverse osmosis cartridges. In this example, the system is capable of outputting more up to about 35 gallons per minute.

### Example 6

FIG. 11 shows a further example of a water treatment system according to the disclosure. In this example, the treatment module incorporates several different treatment modules combined with reverse osmosis module. This example demonstrates one arrangement that may be used in a commercial setting, or in a larger building. In this example, the disclosed treatment system provides up to 80 gallons per minute of output water.

In this example, input water first flows into a prefilter unit 602 that filters material greater than about 20 microns. Water flows into one of three treatment modules 604, 606,608 connected in parallel. In this example, all three treatment modules contain six tanks (three rows) of activated carbon media where the rows in each module are connected in parallel.

Water, having passed through the activated carbon modules then flow into a prefilter unit (610) that filters material greater than about 5 microns.

This example also shows an injection module 612 where anti-scalents or anti-bacterial agents may be introduced into treated water where the ant-scalent reduces water hardness, iron and aluminum and the anti-bacterial agent reduces bacterial contamination. Water may then flow to two pumping systems (614) to maintain flow of water.

In this example, the filtered water flows to one of five reverse osmosis modules (616, 618, 620, 610, 622, 624), linked in parallel.

The foregoing description is meant to be exemplary only and many modifications and variations of the present disclosure are possible in light of the above teachings. It is, therefore, to be understood that within the scope of the disclosure, systems and methods may be practiced otherwise than as specifically described.

1. A water treatment module, comprising:
at least one row of media tanks;
said at least one row of media tanks comprising at least two media tanks;
wherein said at least two media tanks are fluidly connected in parallel; and
wherein said media tanks are vertically orientated in said treatment module;
at least one media manifold;
wherein said at least one media manifold is mounted on top of each of said at least one row of tanks;
an enclosure;
an inlet;
an outlet;
and
a drain;

2. The water treatment module of claim 1, wherein each row of at least one row of media tanks comprises a media selected from the group consisting of catalytic carbon, softener, sediment media, calcite, and media for removal of iron and arsenic.

3. The water treatment module of claim 1, wherein each row of media tanks comprises two media tanks.

4. The water treatment module of claim 1 wherein said water treatment module comprises two rows of media tanks wherein said two rows of media tanks are fluidly connected in parallel.

5. The water treatment module of claim 1 wherein said water treatment module comprises two rows of media tanks wherein said two rows of media tanks are fluidly linked in series.

6. The water treatment module of claim 1 wherein said water treatment module comprises three rows of media tanks wherein a first row of media tanks is positioned immediately adjacent to a second row of media tanks and said second row of tanks is positioned immediately adjacent to a third row of media tanks.

7. The water treatment module of claim 6 wherein said three pairs of media tanks are fluidly connected in parallel.

8. The water treatment module of claim 6 wherein all of said three pairs of media tanks contain the same media.

9. The water treatment module of claim 6 wherein each row of said media tanks is in series with the row of media tanks immediately adjacent.

10. The water treatment module of claim 1, wherein said treatment module is fluidly connected to at least one member selected from the group consisting of a filtration module, a reverse osmosis system, a pump, a calcite module, a water sterilization system, an ultrafiltration system, and combinations thereof.

11. The water treatment module of claim 1, wherein said treatment module is fluidly connected in series with at least one reverse osmosis module.

12. The water treatment module of claim 1, wherein said treatment module is fluidly connected to a pump.

13. The water treatment system of claim 1, wherein each of said at least one media manifold comprises at least one solenoid and at least one gate valve.

14. The water treatment system of claim 1, further comprising at least one serial port connector.

15. A water treatment system, comprising:
a. at least one filtration treatment module;
wherein said at least one filtration treatment module comprises at least one media selected from the group consisting of catalytic carbon, softener, sediment media, calcite, media for removal of iron and arsenic.
b. at least one reverse osmosis module;
wherein said at least one reverse module is fluidly connected in series with said at least one treatment module and said at least one reverse osmosis module receiving water treated by said at least one filtration treatment module.
